(19) United States
(12) Patent Application Publication
(10) Pub. No.: US 2023/0330703 A1
(43) Pub. Date: Oct. 19, 2023

(54) PROCESS FOR COATING THE SURFACE OF WORKPIECES

(71) Applicant: ESS Holding GmbH, Steyr (AT)

(72) Inventors: Alireza Eslamian, Steyr (AT); Martin Schifko, Steyr (AT)

(21) Appl. No.: 17/769,589

(22) PCT Filed: Oct. 14, 2020
(86) PCT No.: PCT/AT2020/060371

§ 371 Date: Apr. 15, 2022

(30) Foreign Application Priority Data
Oct. 16, 2019 (AT) A50892/2019

(51) Int. Cl. B05D 3/02; B05D 3/00; B05D 7/14

(52) U.S. Cl. CPC B05D 3/0281; B05D 3/207; B05D 7/14

(57) ABSTRACT

In a process for coating the surface of workpieces, a coating agent is applied to the workpiece and then cured in an electromagnetic alternating field. In order to enable a high-quality surface coating even with standard coating agents, in particular with liquid coatings, despite the short duration of the process, first the volatile components of the coating agent are expelled in an electromagnetic alternating field having a first frequency spectrum. For the purpose of crosslinking and/or curing the remaining coating agent components, the surface of the workpiece is then heated in an electromagnetic alternating field having a second frequency spectrum, the frequency range of which is below the first frequency spectrum.

### FIELD OF THE INVENTION

The invention relates to a process for coating the surface of workpieces, wherein a coating agent is applied to the workpiece and is subsequently cured in an alternating electromagnetic field.

### DESCRIPTION OF THE PRIOR ART

For the surface coating of workpieces, such as car bodies, electrophoretic dipping processes are known from the prior art. For this purpose, the car bodies are immersed in an electrically conductive dip coating. By applying a DC voltage between the car body, which acts as a cathode, and an anode, the dip coating precipitates on the car body and temporarily adheres there.

DE19941184A1 describes the use of a paint dryer with a cabin interior through which the car body is passed to cure the applied paint. Fresh air heated by heat exchangers is drawn into the cabin interior, which leads to curing or crosslinking of the paint. The resulting exhaust air absorbs toxic solvents from the paint, which is why the exhaust air is subjected to thermal cleaning before being released into the atmosphere. However, such a convection-based process is extremely energy-intensive, since essentially all the air inside the cabin interior must be brought up to the required curing temperature. There is also the problem that, especially with more complex workpieces, the curing of the workpieces is inhomogeneous and differentiated over time because the hot air flows cannot penetrate unhindered into cavities in the workpiece.

To reduce operating costs, it is known from DE112010000464T5 to use UV and near-infrared radiation in addition to curing by convection. The disadvantage of this, however, is that the penetration depth of UV and near-infrared radiation is only very shallow, which is why the UV or near-infrared sources have to be guided close to the workpiece, which in turn leads to a process-related effort for workpieces of different dimensions and design. Particularly in processes that enable rapid curing of the coating agent on the basis of electromagnetic alternating fields, the problem arises that bubble formation and unwanted inclusions of the surface coating cannot be avoided if curing is too rapid.

A process for coating the surface of a workpiece with powder coating is known from EP1541641A1. The powder coating is applied to the workpiece and cured by means of an electromagnetic alternating field, which excites the particles of the powder coating. The alternating field is selected in such a way that the particles of the powder coating are excited, but not the workpiece, which enables the powder coating to be cured in an energy-saving manner. The disadvantage, however, is that the powder coatings to be cured or crosslinked must have particles that can be heated inductively or dielectrically, which is why the process is limited to certain coating materials.

Processes for inductive hardening of workpieces are also known from the prior art. For this purpose, the workpiece is subjected to an alternating magnetic field and thus brought to temperatures of more than 800° C. The duration of exposure is a few seconds in order to prevent complete heating of the workpiece due to heat conduction and thus energy losses.

### SUMMARY OF THE INVENTION

The invention is thus based on the object of proposing a process for surface coating of the type described at the outset which, despite a short process time, enables a high-quality surface coating to be achieved even with standard coating agents, in particular with liquid coatings.

The invention solves the set object by first driving out the volatile components of the coating agent in an electromagnetic alternating field with a first frequency spectrum, whereupon the surface of the workpiece is heated in an electromagnetic alternating field with a second frequency spectrum, the frequency range of which lies below the first frequency spectrum, for the purpose of crosslinking and/or curing the remaining coating agent components. As a result of these measures, the volatile components of the coating agent necessary for uniform application of the coating agent to the workpiece are removed before the actual crosslinking or curing of the coating agent occurs, whereby undesirable inclusions of the volatile components in the cured surface coating can be prevented and thus the quality of the surface coating can be increased. Since the volatile components are polar fluids, such as water or other solvents, frequency spectra in the microwave range, especially decimeter wave range, have been shown to be particularly suitable for driving out these volatile components. After the majority of the volatile components have been expelled from the surface coating, the workpiece is subjected to an alternating field with a second frequency spectrum whose frequency range lies below the first frequency spectrum. A frequency spectrum in the radio wave range, in particular the long-wave and medium-wave range, is suitable for this purpose. This alternating field with low penetration depth into the workpiece excites the surface of the workpiece and thus heats it to a desired temperature. The crosslinking or curing of the remaining coating agent components thus occurs primarily via heat conduction and heat transfer starting from the heated surface of the workpiece, which is why the coating agent does not have to have inductively or dielectrically heatable particles and standard coating agents can therefore be used. Since only the surface of the workpiece needs to be heated, the energy input required is relatively low. Typical temperatures to which the surface of the workpiece should be brought in order to achieve uniform crosslinking and/or curing of the remaining coating agent components without changing the microstructure or the nature of the surface of the workpiece are 100-200° C., preferably 160-190° C.

In order to be able to drive the volatile components out of the coating agent completely and yet in an energy-saving manner, it is proposed that the first frequency spectrum lies in a range of 1-3 GHz. It has been found that this range is suitable for driving out common volatile components of a coating agent even in complex workpiece geometries with any difficult-to-access areas. Depending on the emitters used, the frequency spectrum can also comprise only one or a few frequencies in the specified range.

A suitable second frequency spectrum for heating the surface of the workpiece and thus for crosslinking and/or curing the remaining coating agent components without changing the structure of the workpiece itself, as in the case of curing, for example, lies in a range of 35-400 kHz. This frequency range has the advantage that the electromagnetic alternating field has only a small penetration depth into the workpiece and therefore predominantly excites the surface of the workpiece. In this way, the temperature increase of the workpiece can occur predominantly in an area close to the coating agent, so that energy-efficient heat conduction and heat transfer can occur from the workpiece to the remaining coating agent components to be crosslinked and/or cured, since the alternating field is not used to heat the entire workpiece. Emitters with a power of 60-120 kW have proven to be particularly suitable for generating the electromagnetic alternating fields.

In order to enable an entrapment-free surface coating even in the case of volatile components with low vapor pressure without changing the structure of the workpiece, it is proposed that the workpiece be exposed to the electromagnetic alternating field with the first frequency spectrum for a longer time than to the electromagnetic alternating field with the second frequency spectrum. In this way, it can be ensured that no undesirable volatile components, such as solvents, are included in the surface coating prior to crosslinking and/or curing of the remaining coating components, which further increases the quality of the surface coating.

Preferably, the workpiece can be exposed to the electromagnetic alternating field with the first frequency spectrum for 10-20 minutes and to the electromagnetic alternating field with the second frequency spectrum for 5-10 minutes. The duration of exposure to the alternating field with the second frequency spectrum according to the invention is sufficient for typical car bodies as workpieces to keep the workpiece at a required temperature for a sufficiently long time to enable efficient crosslinking and/or curing of the coating agent. Simulations have shown that the energy input required for workpieces, such as car bodies, to drive out the volatile components is 20-30 kWh and to heat the surface of the workpiece to typical desired temperatures is 10-20 kWh.

In order to ensure that existing devices for surface coating of relatively large workpieces with complex geometries can be easily retrofitted, the electromagnetic alternating fields can be applied with large-area emitters displaceable in at most one spatial direction and with emitters displaceable in at least two spatial directions for areas of the workpiece that are difficult to access. The large-area emitters can, for example, be arranged in a stationary position or on arcuate carriers that can be displaced in one spatial direction relative to the workpiece. The emitters for areas of the workpiece that are difficult to access and can be displaced in at least two spatial directions can, for example, be arranged on multi-axis robot arms.

To further increase the energy efficiency of the process, it is proposed that the coating agent or a curing agent applied prior to curing has inductively or dielectrically heatable particles to which an alternating magnetic field is applied to cure the coating agent. As a result of these measures, the energy required to cure the coating agent is also used to excite the inductively or dielectrically heatable particles. Since the inductively or dielectrically heatable particles are applied to the surface of the workpiece either directly with a coating agent, for example liquid or powder coating, or as a curing agent, direct and loss-free heat transfer of the excited particles to the coating agent applied to the surface of the workpiece and thus energy-saving crosslinking or curing of the coating agent is made possible.

Particularly homogeneous curing of the coating agent on the workpiece surface results when the dielectrically or inductively excitable particles are nanoparticles. As a result of the small dimensions of the particles, the coating agent can be homogeneously heated even in the case of fine surface structures, such as corners or edges, so that the surface coating also cures uniformly in these areas and no harmful stresses arise within the cured layer. The nanoparticles are thus to be regarded as heat sources arranged on the entire surface of the workpiece, which also reach areas of the workpiece that are difficult to access and transfer the energy introduced by the electromagnetic alternating field to the coating agent as thermal energy.

In order to also optimize the coating process preceding the curing process in terms of energy and quality and to keep the processing volume as small as possible, it is proposed that the workpiece is placed in a fluid-impermeable, electromagnetically permeable capsule to which the coating agent is applied and the excess coating agent is drawn off from the capsule, whereupon an alternating electromagnetic field is applied to the capsule to cure the coating agent. As a result of these measures, all the process steps required for surface coating, be it the transport of the workpiece through a production line, the pretreatment of the workpiece, the application of various coating agents and curing agents containing particles that can be heated inductively or dielectrically to the workpiece, can be carried out in a capsule sealed off from the environment. Since the capsule is designed in an electromagnetically permeable manner, it does not interfere negatively with the alternating electromagnetic field, which means that the crosslinking or curing of the coating agents can also be carried out in the capsule. The penetration depth of the electromagnetic waves used is sufficient to excite the surface of the workpiece or the inductively or dielectrically heatable particles applied to the workpiece. Depending on the workpiece, the capsule is dimensioned in such a way that it provides sufficient space to accommodate the workpiece, but still allows the atmosphere enclosed by the capsule (pressure, temperature, humidity, etc.) to be manipulated in the most energy-conserving way possible, thus allowing precise control of the process conditions. The manipulation of the enclosed atmosphere and the application of the coating or curing agents can be carried out by means of connection lines that allow an exchange between the capsule and supply units located along the production line. The capsule is designed as a reaction chamber for surface coating of the workpiece and for manipulation of the atmosphere in the capsule. In principle, to the capsule can be applied substances for pretreating the workpiece, such as cleaning agents, substances for surface coating, such as liquid or powder coatings, curing agents, but also substances for influencing the atmosphere, such as hot air, water vapor and the like.

If it is also desired to cure coating agents that do not contain inductively or dielectrically heatable particles, a curing agent containing inductively or dielectrically heatable particles can be applied to the capsule prior to curing. The curing agent may be supplied simultaneously with, before, or after the coating agent. The curing agent can also be premixed with the coating agent before filling the capsule to ensure the most uniform distribution possible.

To ensure that the coating agents are applied as homogeneously as possible, even to areas of the workpiece that are difficult to access, it is proposed that the capsule is rotated about a horizontal axis of rotation after the coating agent and/or the curing agent is being applied. The rotation can take place during and/or after the application.

### BRIEF DESCRIPTION OF THE INVENTION

In the drawing, the subject matter of the invention is shown by way of example, wherein:

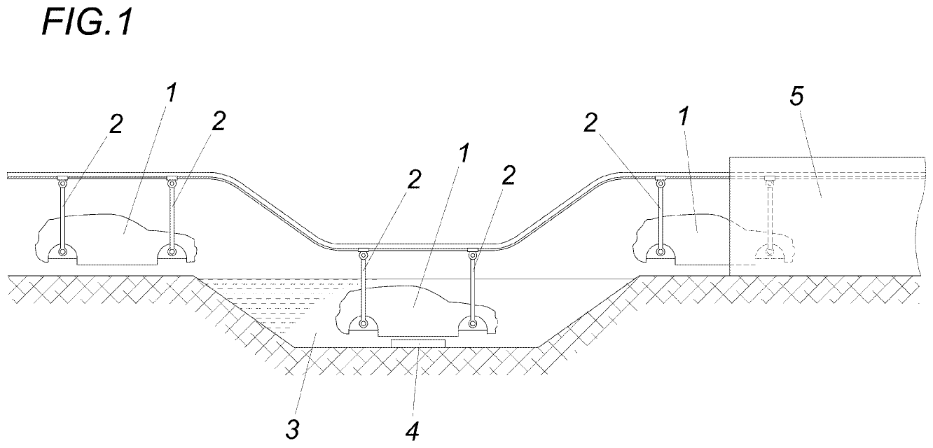

FIG. 1 shows a schematic side view of a production line for carrying out the process according to the invention in accordance with a first embodiment,

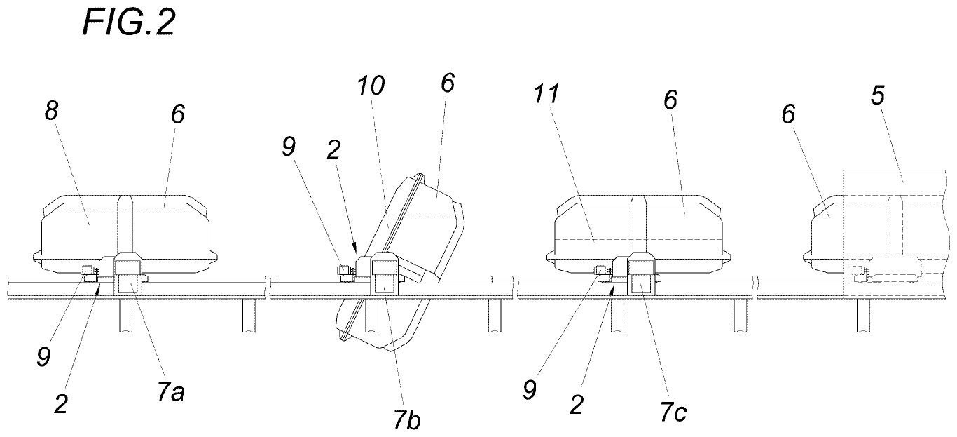

FIG. 2 shows a schematic side view of a production line equipped with electromagnetically permeable capsules for carrying out the process according to the invention in accordance with a second embodiment, and

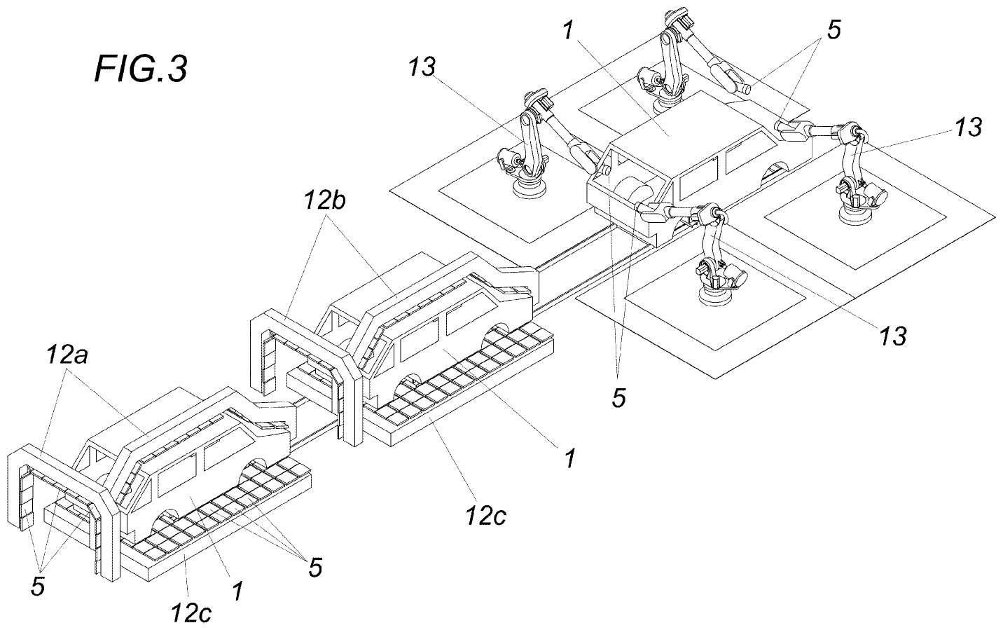

FIG. 3 shows a schematic side view of a production line for carrying out the process according to the invention in accordance with a third embodiment.

### DETAILED DESCRIPTION OF THE PREFERRED EMBODIMENTS

As can be seen in FIG. 1, the process according to the invention can be applied in an electrophoretic deposition process known from the prior art, for example a cathodic dip coating. For this purpose, the workpiece 1 is arranged on a positioning frame 2 and is immersed through a paint bath 3 by a positioning drive (not shown). It is understood that the paint bath 3 is filled with an electrically conductive paint as a coating agent and various additives known from the prior art. If a DC voltage is now applied between the workpiece 1 acting as a cathode and the anode 4 arranged in the paint bath 3, the paint precipitates on the workpiece 1 and remains there. To cure or crosslink, the workpiece 1 is passed through an emitter 5 which generates an electromagnetic alternating field.

With the aid of the electromagnetic alternating field generated by the emitter 5 with a first frequency spectrum, the volatile components, for example water or other volatile solvents, are first expelled from the solvent applied to the workpiece 1. Accordingly, at this first frequency spectrum, the coating agent is predominantly excited by the alternating field, which entails low-energy loss expulsion of the volatile components. Subsequently, the workpiece 1 is subjected to an alternating field with a second frequency spectrum. Since the frequency range of the second frequency spectrum is below the first frequency spectrum, only the surface of the workpiece 1 itself is heated and maintained at a desired temperature. As a result, the thermal energy is also transferred to the remaining coating agent components by thermal conduction and heat transfer, causing them to crosslink and/or cure.

As a first frequency spectrum, a range of 1-3 GHz has proven to be particularly suitable for driving out the volatile components from the applied coating agent.

The second frequency spectrum may be in the range of 35-400 kHz, since it has been found that the energy of this alternating electromagnetic field is high enough to heat the surface of the workpiece 1, but not to change its microstructure.

In the case of common car bodies as workpieces, the best results with regard to a high-quality and yet energy-saving surface coating have been obtained when the workpiece 1 is exposed to the electromagnetic alternating field with the first frequency spectrum for 10-20 minutes and to the electromagnetic alternating field with the second frequency spectrum for 5-10 minutes. In principle, it can be stated that tests in which the workpiece 1 has been exposed to the electromagnetic alternating field with the first frequency spectrum for longer than to the electromagnetic alternating field with the second frequency spectrum have tended to result in better surface coatings.

FIG. 2 shows a further embodiment of the surface coating process according to the invention. For this purpose, the workpiece 1, which is not shown for reasons of clarity, is arranged in an electromagnetically permeable capsule 6. The capsule 6 thus forms a sealed reaction chamber which can be filled or emptied via supply units 7a, 7b, 7c. If the surface coating is, for example, an electrophoretic deposition process, a first supply unit 7a can apply a cleaning agent 8 to the interior of the capsule for removing grease or paint residues adhering to the workpiece 1. After the cleaning agent 8 has been removed by the supply unit 7a, the capsule 6 is uncoupled and conveyed with the aid of a positioning drive 9 of a positioning frame 2 to a further supply unit 7b, which fills the capsule interior, for example, with an electrolyte 10 for producing a conversion layer on the workpiece 1 and then empties it again. A third supply unit 7c can supply electrically conductive liquid paint 11 to the capsule interior for coating the workpiece. A DC voltage field is now applied between the workpiece 1 connected as a cathode, for example, and an anode mounted in the capsule 6, as a result of which the paint particles on the workpiece 1 precipitate. It probably need not be mentioned further that the workpiece 1 can also be connected as an anode. In this case, a cathode must be arranged in the capsule 6. In a final process step, the applied coating is crosslinked by passing the capsule 6 with the workpiece 1 arranged in it through the electromagnetic alternating field of an emitter 5.

As further shown in FIG. 2, the capsule 6 can be rotated about a horizontal axis of rotation at the supply units 7b for sufficient distribution of the coating agents applied. It is understood that the production line can be designed in such a way that the capsule 6 can also be rotated at other positions.

The different filling levels of the cleaning agent 8, the electrolyte 10 and the liquid coating 11, indicated by dashed lines, show the different process steps in time during filling and emptying of the capsule contents.

The capsules 6 can be hermetically sealed and are designed in two parts, which favors easy loading of the capsules 6 with a workpiece 1.

FIG. 3 shows possible embodiments of the emitters 5 for application of the electromagnetic alternating fields. In order that the process according to the invention can also be applied to large workpieces 1 and moreover to existing production lines, the electromagnetic alternating fields can be applied with large-area emitters 12 which can be displaced in at most one spatial direction. Due to the displacement in only one spatial direction, no complex control devices are necessary, whereby production lines can be upgraded with the process according to the invention in a cost-effective manner. The alternating field with a first frequency spectrum for driving out the volatile components can be applied via a first large-area emitter 12a, and the alternating field with a second frequency spectrum for crosslinking and/or curing the remaining coating agent components can be applied via a second large-area emitter 12b. The large-area emitter 12 can, for example, comprise several emitters 5. It is also conceivable that a large-area emitter 12c that cannot be moved in any spatial direction is also provided. To ensure that even complex geometries can be surface-coated in a process-safe manner, areas of the workpiece 1 that are difficult to access can be subjected to an alternating electromagnetic field generated by emitters 5 that can be displaced in at least two spatial directions. These emitters 5 can be displaced by robot arms 13, for example.

1. A process for coating the surface of workpieces, said process comprising:
applying a coating agent to the workpiece and thereafter curing the workpiece in an electromagnetic alternating field;
wherein volatile components of the coating agent are first expelled in a first electromagnetic alternating field having a first frequency spectrum, and
wherein the surface of the workpiece is then heated in a second electromagnetic alternating field having a second frequency spectrum having a frequency range that is below the first frequency spectrum so as to crosslink and/or cure coating agent components remaining after the volatile components are expelled.

2. The process according to claim 1, wherein the first frequency spectrum is in a range of 1 to 3 GHz.

3. The process according to claim 1, wherein the frequency range of the second frequency spectrum is 35 to 400 kHz.

4. The process according to claim 1, wherein the workpiece is exposed to the first electromagnetic alternating field with the first frequency spectrum for a first period of time that is longer than a second period of time to which the workpiece is exposed to the second electromagnetic alternating field with the second frequency spectrum.

5. The process according to claim 1, wherein the workpiece is exposed to the first electromagnetic alternating field with the first frequency spectrum for 10 to 20 minutes and to the second electromagnetic alternating field with the second frequency spectrum for 5 to 10 minutes.

6. The process according to claim 1, wherein the electromagnetic alternating fields are applied with large-area emitters that are supported so as to be displaceable in at most one spatial direction and with emitters displaceable in at least two spatial directions for areas of the workpiece that are difficult to access with the large area emitters.

7. The process according to claim 1, wherein the coating agent or a curing agent applied prior to curing comprises inductively or dielectrically heatable particles, and an alternating magnetic field is applied to the heatable particles so as to cure the coating agent.

8. The process according to claim 7, wherein the dielectrically or inductively heatable particles are nanoparticles.

9. The process according to claim 1, wherein the process further comprises placing the workpiece a fluid-impermeable, electromagnetically permeable capsule, to which the coating agent is supplied and withdrawing an excess of the coating agent from the capsule, and then applying an electromagnetic alternating field to the capsule so as to cure the coating agent.

10. The process according to claim 9, wherein a curing agent comprising inductively or dielectrically heatable particles is supplied to the capsule before curing.

11. The process according to claim 9, wherein the capsule is rotated about a horizontal axis of rotation after the coating agent and/or the curing agent is being supplied.

12. The process according to claim 10, wherein the capsule is rotated about a horizontal axis of rotation after the coating agent and/or the curing agent is being supplied.

13. The process according to claim 2, wherein the frequency range of the second frequency spectrum is 35 to 400 kHz.

14. The process according to claim 2, wherein the workpiece is exposed to the first electromagnetic alternating field with the first frequency spectrum for a first period of time that is longer than a second period of time to which the workpiece is exposed to the second electromagnetic alternating field with the second frequency spectrum.

15. The process according to claim 3, wherein the workpiece is exposed to the first electromagnetic alternating field with the first frequency spectrum for a first period of time that is longer than a second period of time to which the workpiece is exposed to the second electromagnetic alternating field with the second frequency spectrum.

16. The process according to claim 13, wherein the workpiece is exposed to the first electromagnetic alternating field with the first frequency spectrum for a first period of time that is longer than a second period of time to which the workpiece is exposed to the second electromagnetic alternating field with the second frequency spectrum.

17. The process according to claim 2, wherein the workpiece is exposed to the first electromagnetic alternating field with the first frequency spectrum for 10 to 20 minutes and to the second electromagnetic alternating field with the second frequency spectrum for 5 to 10 minutes.

18. The process according to claim 2, wherein the coating agent or a curing agent applied prior to curing comprises inductively or dielectrically heatable particles, and an alternating magnetic field is applied to the heatable particles so as to cure the coating agent.

19. The process according to claim 3, wherein the coating agent or a curing agent applied prior to curing comprises inductively or dielectrically heatable particles, and an alternating magnetic field is applied to the heatable particles so as to cure the coating agent.

20. The process according to claim 13, wherein the coating agent or a curing agent applied prior to curing comprises inductively or dielectrically heatable particles, and an alternating magnetic field is applied to the heatable particles so as to cure the coating agent.
